(19) United States
(12) Patent Application Publication
(10) Pub. No.: US 2011/0300933 A1
(43) Pub. Date: Dec. 8, 2011

(54) METHOD FOR INTERACTING WITH A VIDEO AND GAME SIMULATION SYSTEM

(75) Inventors: SHAO-YI CHIEN, Taipei (TW); JUI-HSIN LAI, Taipei (TW)

(73) Assignee: NATIONAL TAIWAN UNIVERSITY, Taipei (TW)

(21) Appl. No.: 12/939,082

(22) Filed: Nov. 3, 2010

(30) Foreign Application Priority Data
Jun. 8, 2010 (TW) 099118563

(51) Int. Cl. A63F 13/00; G09G 5/08

(52) U.S. Cl. 463/31; 345/158

(57) ABSTRACT

A method for interacting with a video by a motion detector is disclosed. First, a video-content-decomposition procedure is executed to decompose the video into a background scene and at least one foreground object. Then, at least one event database is classified according to the state of the foreground object. Finally, the suitable foreground objects are selected from the event database according to a detected motion by the motion detector. Wherein, the foreground objects selected are rendered on the background scene sequentially according to the detected motion.

### CROSS-REFERENCE TO RELATED APPLICATIONS

The entire contents of Taiwan Patent Application No. 099118563, filed on Jun. 8, 2010, from which this application claims priority, are incorporated herein by reference.

### BACKGROUND OF THE INVENTION

1. Field of the Invention

The present invention generally relates to an interacting method and a simulation system, and more particularly to a method for interacting with a video and a game simulation system.

2. Description of Related Art

It has become a popular entertainment that most people watch sport games via a television or a computer. In current sportscasts, however, it is usually only allowed for people to accept a video content provided by the broadcaster unilaterally, while interacting with the video content is not provided to a viewer. Therefore, people may feel emptiness after finishing watching the game video.

In order to increase the applications of a video, some video decomposition technologies would be developed gradually to perform image processing adaptively. The concept of Bayesian Matting is usually used to decomposing the video frame into a background scene and at least one foreground object. However, user must indicate the foreground regions for each frame to separate into the foreground objects correctly. Specifically, user requires human-assistance to outline the foreground objects and then generates a trimap which is a map indicating the foreground (black), background (white), and unknown (gray) regions on each image. Finally, put the trimap data into formula to generate the foreground objects decomposed. The generation of a trimap is time consuming and requires human-assistance, especially when performing the above complicated compiling process for the whole video.

Therefore, how to provide a customized, easy-made and interactive game video for the viewer and thus more enjoyment on game watching is the object to be achieved by the present invention.

### SUMMARY OF THE INVENTION

In view of the foregoing, it is an object of the embodiment of the present invention to provide a method for interacting with a video content, which is capable of operating the video content interactively, resulting in more enjoyment on game watching obtained by a video viewer.

It is another object of the embodiment of the present invention to provide a method for interacting with a video content, which is capable of decomposing a video into a background scene and at least one foreground object automatically, thereby facilitating to simplify the image process.

To achieve the above objects, the present invention provides a method for interacting with a video by a motion detector, comprising the steps of: first, a video-content-decomposition procedure is executed to decompose the video into a background scene and at least one foreground object. Then, at least one event database is classified according to the state of the foreground object. Finally, the suitable foreground objects are selected from the event database according to a detected motion by the motion detector. Wherein, the foreground objects selected are rendered on the background scene sequentially according to the detected motion.

It is a further object of the embodiment of the present invention to provide a game simulation system which analyzes the current situations of various contestants when competing, thereby simulating the competition result of the contestants each other.

To achieve the above objects, the present invention provides a game simulation system comprising a database and a processor unit. The processor unit is configured to decompose at least one game video of at least one contestant into a plurality of foreground objects and classify the movement categories of the contestants to store in the database according to the movement of the foreground objects. Therefore, the competition result of the contestants could be simulated according to the movement categories of one contestant and another contestant in the database.

### BRIEF DESCRIPTION OF THE DRAWINGS

FIG. 1 shows a black diagram of a video transmitting architecture according to one embodiment of the present invention.

FIG. 2 shows a diagram illustrating the foreground and background are transmitted separately according to one embodiment of the present invention.

FIG. 3 shows an algorithm diagram of decomposing the foreground and background automatically according to one embodiment of the present invention.

FIG. 4 shows a diagram illustrating a foreground database according to one embodiment of the present invention.

FIG. 5 shows a diagram illustrating a strength chart according to one embodiment of the present invention.

FIG. 6 shows a diagram illustrating a moving path tended towards according to one embodiment of the present invention.

FIG. 7A shows a diagram illustrating motion smoothing according to one embodiment of the present invention.

FIG. 7B shows a diagram illustrating a structure combining 3D model with video-based rendering according to one embodiment of the present invention.

FIG. 8 shows a flow diagram illustrating a method for interacting with a video content according to one embodiment of the present invention.

### DETAILED DESCRIPTION OF THE INVENTION

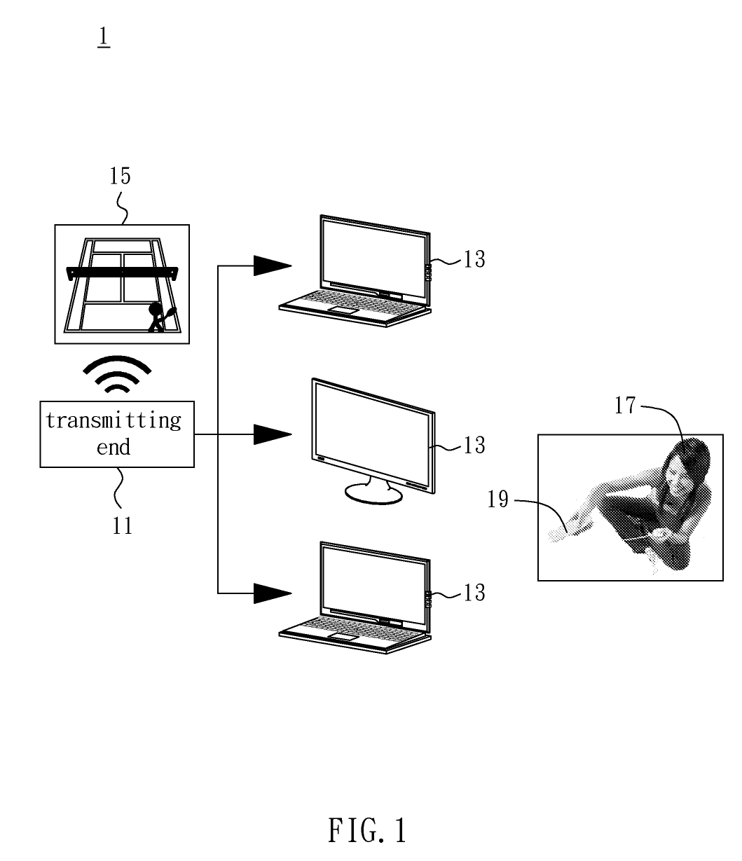

Firstly, please refer to FIG. 1 which shows a black diagram of a video transmitting architecture according to one embodiment of the present invention. As shown in FIG. 1, the video transmitting architecture 1 comprises a transmitting end 11 and a receiving end 13. The transmitting end 11 is configured to transmit a video 15 to the receiving end 13 via an internet or by wireless transferring. The user 17 located at the receiving end 13 controls the player (or avatar) according to a detected motion by a motion detector to interactive with the content of the video 15, and the motion detector is selected from a group consisting of user-operated controller, motion sensor, or image sensor and combinations thereof. The motion sensor comprises an Xbox 360 motion-sensor and the user-operated controller comprises a remote controller 19. The input operations of the remote controller 19 comprises input instructions from a keyboard, input instructions from a mouse, input instructions from a joystick, dynamical input from Wiimote™, dynamical input from PlayStation® Move, or the combinations thereof. Specifically, the receiving end 13 comprises a personal computer, notebook, TV, etc.

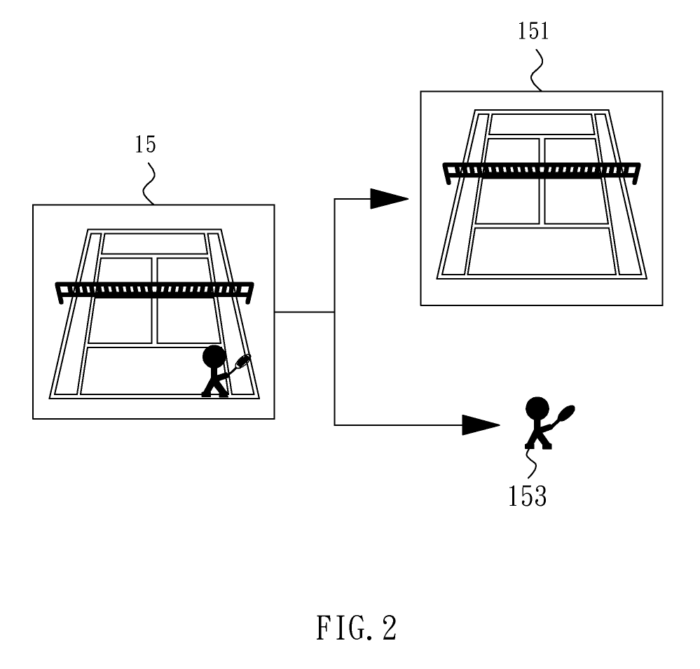

In one embodiment of the present invention, the background and the foreground object in the video 15 are transmitted separately. Take a tennis game video as example hereinafter, as shown in FIG. 2, the background scene 151 such as a stadium or an auditorium and the foreground objects 153 such as a player or a tennis ball are separately transmitted to the receiving end 13 to be stored. With regard to the technique for decomposing the video frame into a background scene and a foreground object, please refer to Taiwan Patent Nos. 98111457 and 98118748, and U.S. patent application Ser. Nos. 12/458,042 and 12/556,214, the details of which are incorporated herein by reference, so no more details will be provided here.

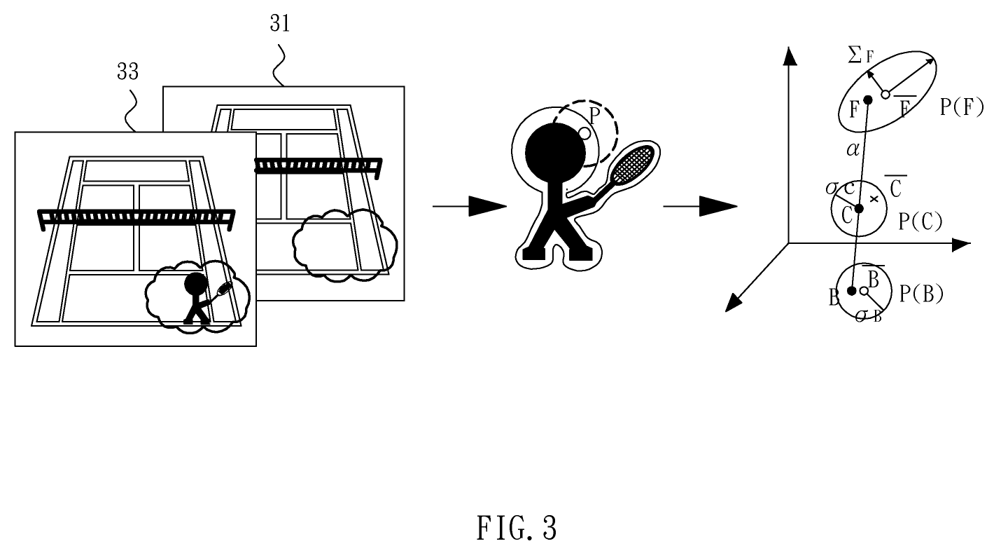

It requires human-assistance to outline the foreground objects to separate the background and the foreground in prior art, in view of the above defect, some threshold values indicating the pixel difference would be pre-determined to distinguish between background and foreground in the present invention. Please refer to FIG. 3, which shows an algorithm diagram of decomposing the foreground and background automatically according to one embodiment of the present invention. As shown in FIG. 3, a high threshold value Tₕ and a low threshold value Tₗ are pre-determined, and each frame 33 in the video 15 may be compared with the background frame 31 to get their difference. The portion that the difference between frame 33 and background frame 31 is lower than the low threshold value Tₗ is regarded as background region, and the portion that the difference between frame 33 and background frame 31 is higher than the high threshold value Tₕ is regarded as foreground region. The portion that the difference within the range between the high threshold value Tₕ and the low threshold value Tₗ is regarded as unknown or gray region, which is usually the rim of the foreground objects 153, therefore the trimap would be generated automatically. Then, each pixel on gray region would be calculated weighted with an alpha value α by formula (1) to obtain the rim color C of the foreground objects 153, wherein the alpha value α is the pixels opacity component used to linearly blend between foreground and background. Finally, put the rim color C data into formula (2) to obtain the exact outline of the foreground object 153. Wherein, the formulas (1) and (2) are often used in Matting Procedure technique, with regard to the definition of their parameters or the theory please refer to the “Tennis Real Play” document, disclosed by Jui-Hsin Lai et al., is contributed to ACM Transactions on Multimedia Computing, Communication and Applications on Apr. 10, 2010, which is herein incorporated by reference.

$$\begin{matrix}C = α F + ( 1 - α ) B , & ( 1 ) \\ [ \begin{matrix}{\sum }_{F}^{- 1} + I {α}^{2} / {σ}_{C}^{2} & I α ( 1 - α ) / {σ}_{C}^{2} \\ I α ( 1 - α ) / {σ}_{C}^{2} & I ( 1 / {σ}_{B}^{2} + {( 1 - α )}^{2} / {α}^{2} )\end{matrix} ] [ \begin{matrix}F \\ B\end{matrix} ] = [ \begin{matrix}{\sum }_{F}^{- 1} \overline{F} + C α / {σ}_{C}^{2} \\ \overline{B} / {σ}_{B}^{2} + C ( 1 - α ) / {σ}_{C}^{2}\end{matrix} ] & ( 2 )\end{matrix}$$

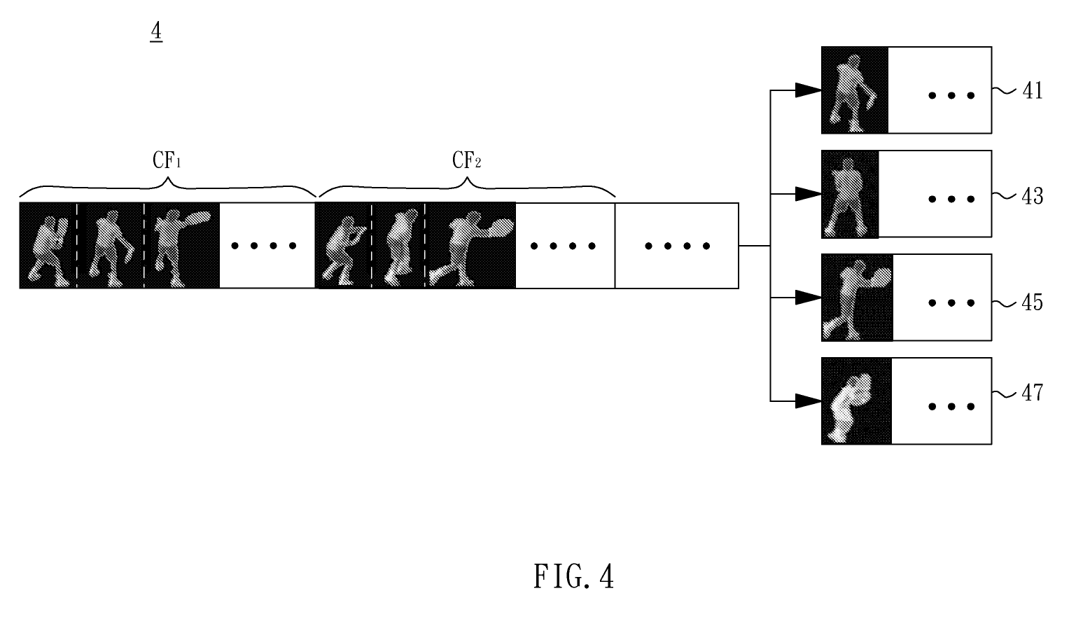

Sequentially, please refer to FIG. 4, which shows a diagram illustrating a foreground database according to one embodiment of the present invention. As shown in FIG. 4, the video 15 is composed of a plurality of sequent frame clips CF₁, CF₂, . . . , and each sequent frame clip is composed of a plurality of frames. During transmitting, each foreground object 153 would be stored in a foreground database 4 in sequence with timeline of the corresponding sequent frame clips. Wherein, the foreground database 4 can be configured at the transmitting end 11 or the receiving end 13. The present invention provides a model imitating human behavior, in one specific embodiment, the foreground database 4 is classified as at least one event database according to the state or the motion of the foreground objects 153 stored. Take a tennis game video as example, all the behavior of a tennis player can be composed by these state transitions, serving, standby, hit, and moving, therefore the foreground database 4 could be divided into four event databases, serving database 41, standby database 43, hit database 45, and moving database 47, which separately stores related state of the foreground objects 153. In practical operation, the event database can be classified by pointing to the corresponding foreground objects 153 in the foreground database 4, or be stored individually. The event database may, but is not limited to, store other various states according to the video content.

After building the complete event database, the foreground objects 153, which conform to the game scenario, can be selected from the event database to be displayed on the background scene 151 in sequence according to a detected motion by the motion detector, wherein the detected motion could comprise the motion of the user or the motion of the remote controller 19 controlled by user 17. In one embodiment, due to various sizes of the foreground objects 153 decomposed, the event database must be preformed normalizing procedure to adjust the position and size of each foreground object 153 on the background scene. With regard to the detail database normalization technique, please refer to Taiwan Patent Nos. 98111457 and 98118748, and U.S. patent application Ser. Nos. 12/458,042 and 12/556,214, incorporated herein by reference; thus, no more details will be described here.

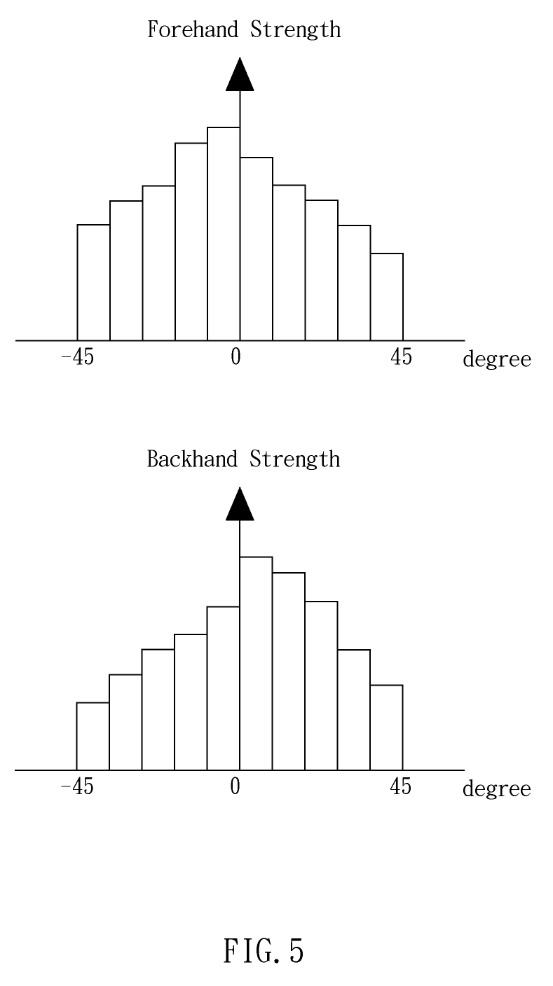

In order to interactive with the video 15 realistically, it further analyzes and records the moving directions and speeds of each foreground object 153 in the present invention. Take a tennis game video as example, the hitting properties of player is in accordance with statistics in game video. Therefore, the forehand hitting strength, backhand hitting strength, or hitting degree of a player would be analyzed and gathered by hitting sound volume or motion speed of the ball in the video to generate a strength chart. As shown in FIG. 5, the strength chart shows hitting statistics of forehand strength and backhand strength in each direction. When hitting ball by waving hands or waving the remote controller 19, in addition to depend on the waving strength, user 17 can control the moving direction and speed of the ball according to waving degree to select corresponding hitting strength in the strength chart, and further the moving direction and speed of the ball which is hit would be controlled. Therefore, when interacting with the video, not only the waving strength from user but also the sport habits of the player would be considered and calculated weighted to determine the moving direction and speed of the ball, therefore improves vivid effect.

It is worth mentioning that in addition to hitting strength and directions, the properties of the player (foreground object 153) in the video 15 such as moving path, hitting motion, or hitting behavior can be analyzed according to the game video content. When interacting with the video, the adaptive foreground objects 153 would be selected to display according to the properties of the foreground objects 153 analyzed previously. Therefore, in addition to vivid visual effect, the action of the avatar may be adjusted slightly according to the behavior of the real player, and further improves reality. Moreover, after analyzing the sport properties of various players, we can control two players to compete with each other, and forecast victory or defeat of the players according to their properties.

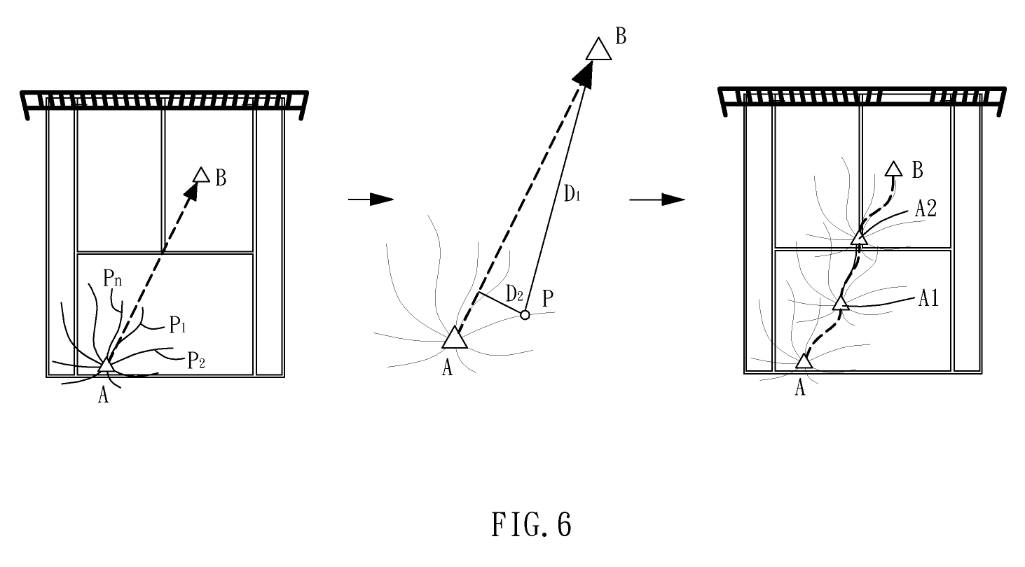

Please refer to FIG. 6, which shows a diagram illustrating a moving path tended towards according to one embodiment of the present invention. We suppose to render a motion path from beginning position A to destination position B as the illustration in FIG. 6, and the better moving path is the shortest path like the dotted line. However, it is hard to find a sequent frame clip from the moving database 47 to fit the dotted line, and multiple sequent frame clips should be connected to form the moving posture. As shown in FIG. 6, at least one sequent frame clip, which is close to the path from beginning position A to destination position B, would be selected from the moving database 47, and then be displayed in sequence. Specifically, base on the foreground object 153 of beginning position A, each sequent frame clip (in accordance with a plurality of path P₁, P₂, . . . , Pₙ) in the moving database 47 must be compared, and further determine a relay point P. Wherein, the distance D₁ which is the distance from beginning position A to relay point P, the distance D₂ which is the distance between from relay point P to the shortest path (i.e. line AB), and the clip length of sequent frame clip must be calculated weighted to determine that which path P₁, P₂, . . . , Pₙ is the best path which is close to the line AB. If the distance D₁ and D₂ are shorter, the path selected is closer to the line AB. If the clip length of single sequent frame clip is more, the distance the foreground object 153 moves is more in the sequent frame clip, i.e., closer to the destination position B. Therefore, less number of sequent frame clips would be connected to form the moving path from beginning position A to destination position B, and the motion of the foreground object 153 displayed may be smoother. As shown in FIG. 6, path P₁ is closest to line AB, then the relay point P is set as new beginning position and find another moving path which is closest to line PB, and repeat the above steps until all path A-A1, A1-A2, A2-B which is close to line AB would be found. Finally, the foreground objects 153 corresponding to the above path should be displayed on the background scene 151 in sequence.

In one preferred embodiment, the moving directions of the foreground objects 153 can be simplified previously. For example, here, 360 degrees of moving direction are segmented into small buckets, and each bucket has 30 degrees. It limits 12 moving directions, therefore time and system resource may be reduced. Furthermore, the motions of sequence foreground objects 153 in single sequent frame clip are smooth and coherent, but the motions of sequence foreground objects 153 in different sequent frame clips are not. Therefore, the less the number of sequent frame clips which are close to path AB are, the better it is. In other words, the more the number of the foreground objects 153 between relay point P and beginning position A are, the better it is. In the case, least number of sequent frame clips would be connected to form the moving path from beginning position A to destination position B, and improve motion smooth of the foreground objects 153.

The adaptive foreground objects 153 would be selected to display on the background scene 151 according to the detected motion such as the motion of the user or the motion of the remote controller 19 controlled by user 17 in the present invention. When user 17 change current state of motion, the corresponding foreground objects 153 may be selected from adaptive event database to display. Specifically, when user 17 serves, the adaptive foreground objects 153 are selected from the serving database 41 to display, and when user 17 hits, the adaptive foreground objects 153 are selected from the hit database 45, and so on. Due to the human behavior model and the corresponding event databases, the frames can be rendered smoothly when change states of player.

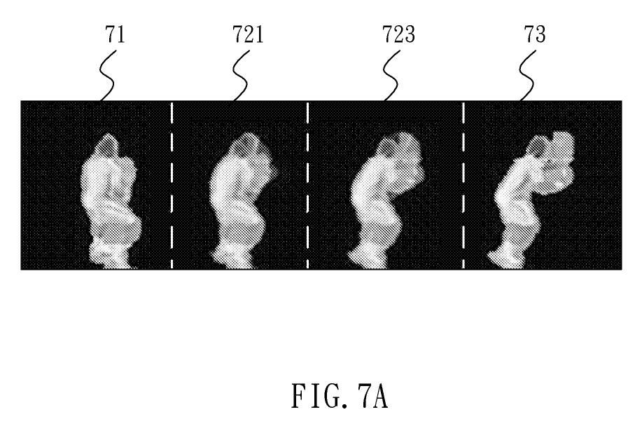

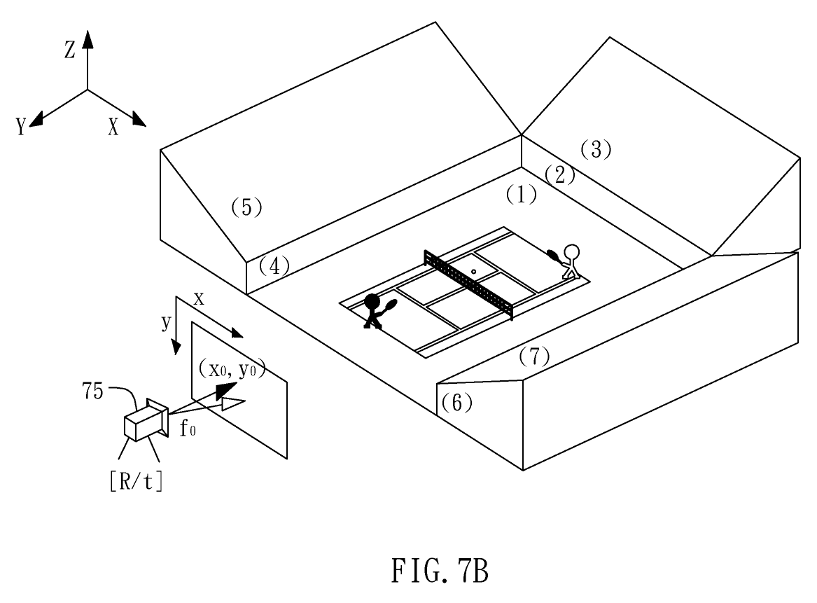

In one specific embodiment, each foreground object 153 has a texture feature and a shape feature, which indicate the color and shape information of the foreground object 153, respectively. For a suitable connection, the next foreground object 153 in a successive clip should have visual similarity between current clip according to the texture and the shape features. However, when the avatar on the frame change its state, e.g., change from standby state to hit state, the selected foreground objects 153 may not be similar enough to current foreground objects 153, and the rendering result will look weird if directly cascading two frame clips. To make the transition smooth, we propose at least one smooth frame between two cascading frame clips in the present invention. The transition frames are calculated by current clip and selected clip with the consideration of smoothness of shape, color and motion. Please refer to FIG. 7A, which shows a diagram illustrating motion smoothing according to one embodiment of the present invention. As shown in FIG. 7A, the foreground objects 71, 73 are stored in the event database originally. If the foreground object 73 is selected to connect successively to foreground object 71, due to the reason that the differences of the texture and a shape features between the foreground objects 71, 73 are too large, a smooth frame may be simulated to interpolate between two frame clips of the foreground objects 71, 73.

A game system not only includes the foreground objects 153 rendering but also contains the vivid background scene 151 rendering. And 3D scenes can be rendered from 2D image after user manually labels the 3D structure of the image. The present invention further provides an image producing technique, which combines 3D rendering to make the background scene 151 vivid in various viewing angles, to render the virtual 2D background scene 151 from 3D structure in any viewing angle. Please refer to FIG. 7B, which shows a diagram illustrating a structure combining 3D model with video-based rendering according to one embodiment of the present invention. As shown in FIG. 7B, take the tennis game as example, the 3D structure of tennis court can be roughly modeled as seven boards: (1) floor, (2) bottom of bottom audience, (3) top of bottom audience, (4) bottom of left audience, (5) top of left audience, (6) bottom of right audience, and (7) top of right audience. The 2D background scene 151 rendered from 3D structure is controlled by intrinsic and extrinsic parameters of the camera 75 in formula (3), where f₀ is focal length and [xₒ, yₒ] are offset coordinates of, intrinsic parameters. The rotation matrix R and translation matrix t are extrinsic parameters ([xₒ, yₒ]). When playing game, with modifying there camera 75 parameters, we can render the virtual 2D background scene 151 from 3D structure in any viewing angle.

$$[ \begin{matrix}x \\ y \\ 1\end{matrix} ] \sim [ \begin{matrix}{f}_{0} & 0 & {x}_{0} \\ 0 & {f}_{0} & {y}_{0} \\ 0 & 0 & 1\end{matrix} ] [ R \vert t ] [ \begin{matrix}X \\ Y \\ Z \\ 1\end{matrix} ] \qquad ( 3 )$$

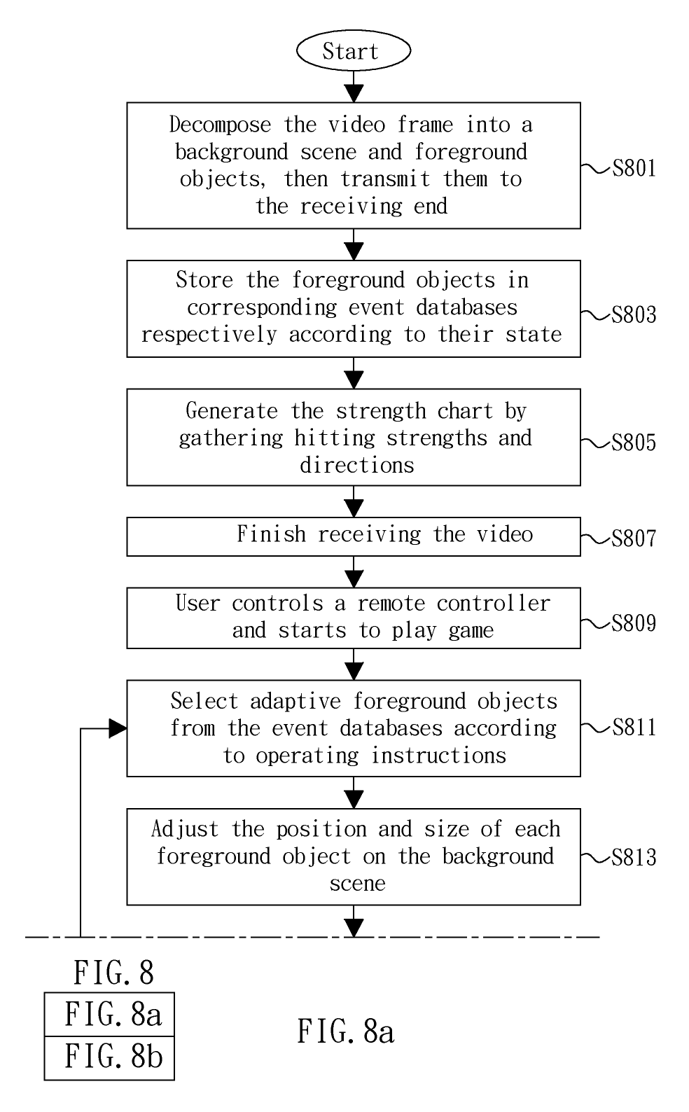

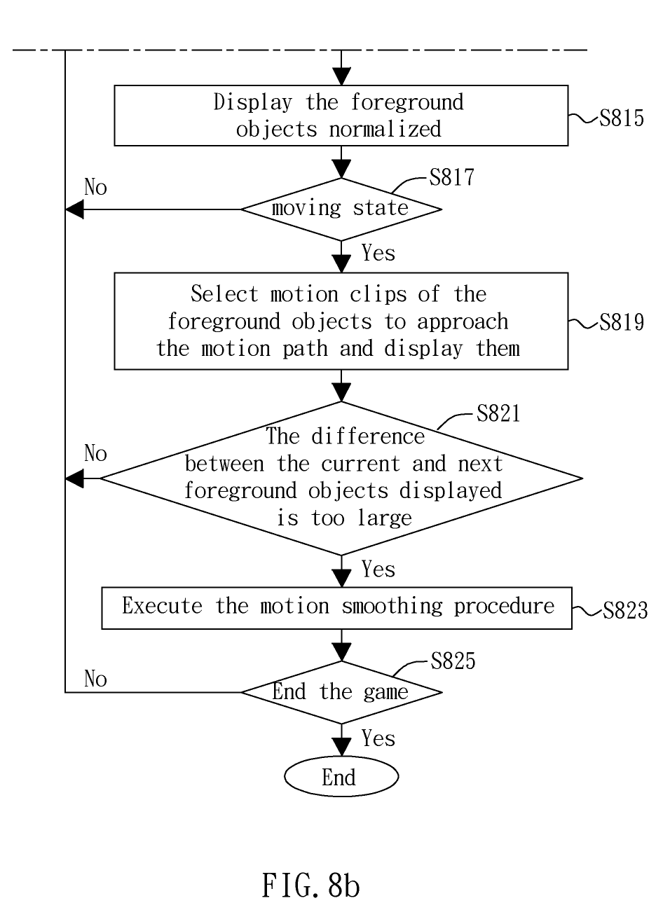

Finally, please refer to FIG. 8, which shows a flow diagram illustrating a method for interacting with a video content according to one embodiment of the present invention. Still take the tennis game video as example, as shown in FIG. 8, the method comprises the following steps:

First, a video-content-decomposition procedure is executed in the transmitting end 11 to decompose the video into a background scene 151 and a plurality of foreground objects 153 which are transmitted to the receiving end 13 in sequence in step S801. During transmitting, the states of the decomposed foreground objects 153 are determined in the transmitting end 11, and the receiving end 13 stores them into corresponding event databases respectively according to the state of the foreground objects 153 in step S803. Then, in step S805, the transmitting end 11 generates the strength chart by gathering hitting strengths and directions of the foreground objects 153 according to the hitting sound volume or motion speed of the ball in the video 15. In one specific embodiment, the video-content-decomposition procedure may be executed by the receiving end 13 after transmitting the whole video 15 from the transmitting end 11. The states of the decomposed foreground objects 153 may be determined to classify by the receiving end 13, and the strength chart may be generated by the receiving end 13 which analyzes each foreground object 153.

In step S807, when finishing receiving the whole video 15, the database and relative information have been built, the user interacts with the video 15 according to the detected motion by the motion detector, for example, the user controls the remote controller 19 to interact with the video 15 and starts to play game in step S809. At beginning of the game, a foreground object 153 is selected from the serving database 41 to display on the background scene 151 (tennis court). Then, in step S811, some adaptive foreground objects 153 are selected from the event databases according to the detected motion such as the motion of the user or the operating instructions by waving or inputting the remote controller 19. For example, when user 17 wants to hit the tennis ball back, the specific foreground object 153 in accordance with the hitting degree would be found from the hit database 45 to display. Wherein, the moving direction and speed of the tennis ball is controlled according to the waving strength from user 17 or the strength chart.

Due to various sizes of the foreground objects 153 decomposed, the selected foreground object 153 must be preformed a normalizing procedure to adjust the position and size of each foreground object 153 on the background scene 151, in step S813, before displaying the normalized foreground object 153 in step S815.

Moreover, in step S817, the current foreground object 153 is determined whether it changes into moving state according to the detected motion such as the motion of the user or the operation of the remote controller 19. If not, still select the adaptive foreground objects 153 from the event databases according to the detected motion or operating instructions of the remote controller 19. If the state of the current foreground object 153 will be changed into moving state, in step S819, a moving path closing procedure is executed to find the sequence frame clips of foreground objects 153 which are close to the moving path. Specifically, the beginning position where the foreground object 153 currently locates at must be detected and the destination position where the foreground object 153 want to move to must be forecasted. Then, at least one sequence frame clip, which is close to the path from the beginning position to the destination position, is found from the moving database 47. The found sequence frame clips of the foreground objects 153 are displayed sequentially.

In step S821, the difference between the current and the next foreground objects 153 displayed is always determined whether it is too large or not, e.g., more than a default threshold value. If not, the step S811 is still processed. If the difference between two foreground objects 153 is too large, a smoothing procedure is executed to interpolate at least one smooth frame antecedent to the next displayed frame clip of the foreground object, in step S813.

Finally, determine whether the user 17 wants to end the game, in step S825. If so, this turn of the interactive game is finished. If not, the step S811 is still processed.

Note that, determining the difference and the relative process (steps S821-S823) may, but is not limited to, be executed before the moving path closing procedure (steps S817-S819).

According to the above embodiment, the method for interacting with a video content, provided in the present invention, decomposes the video content and displays adaptive foreground objects in sequence according to the video scenario, which is capable of interacting with the video content, resulting in more enjoyment on game watching obtained by a video viewer. Furthermore, the present invention utilizes the threshold value to distinguish between background and foreground automatically, which avoids human-assistance outlining each foreground object, thereby facilitating to simplify the image process.

In view of the foregoing, the present invention further provides a game simulation system to forecast victory or defeat. Please refer to FIGS. 1-8 with regard to the relative process. The game simulation system comprises a database (such as foreground database 4) and a processor unit. The processor unit is configured to decompose at least one game video of at least one contestant into a plurality of foreground objects 153 and classify the movement categories of the contestants to store in the database. Therefore, the competition result of the contestants could be simulated according to the movement categories of one contestant and another contestant in the database.

Similarly, the processor unit may decompose at least one game video of another contestant into a plurality of foreground objects 153 and classify the movement categories of the contestant to store in the database. Moreover, the game comprises one-to-one competition (such as tennis, table tennis, pugilism, taekwondo), many-to-many competition (such as doubles tennis, basketball, soccer), or one-to-many competition (such as baseball).

Take the combat competition such as pugilism or taekwondo as example, the foreground objects 153 comprise the contestants which fight each other, and the movement of the foreground objects 153 comprises moving directions, moving speed, or moving distance of the contestants. Moreover, the processor unit gathers these moving directions, moving speed, or moving distance of the foreground objects 153 to generate the corresponding strength charts of these contestants, respectively, thereby determining the attack strength of these contestants. The above movement category comprises punching state, kicking state, defense state, and moving state, which are stored in the corresponding event database.

Take taekwondo as example, the processor unit decomposes one (or many) taekwondo competition video of a contestant A into a plurality of foreground objects, and generates the movement categories (punching state, kicking state, defense state, and moving state) of the contestant A according to the movement of the foreground objects (moving directions, moving speed, or moving distance of the contestant A). All states are stored in the database, and each state is stored in corresponding event database respectively. For example, the processor unit analyzes the moving directions, moving speed, or moving distance of fists of the contestant A and obtains plural punching states, and stores them in a punching database. Certainly, database further comprises a kicking database, a defense database, and a moving database. Similarly, the processor unit also can analyze one (or many) taekwondo competition video of another contestant B and generate various movement categories. Then, the processor unit simulates the competition result of the contestants A, B according to the movement categories (punching state, kicking state, defense state, and moving state) of the contestants A, B.

Still take the tennis game as example, the processor unit decomposes one (or many) tennis game video of the contestants (players) A, B into a plurality of foreground objects, and generates the movement categories (serving state, standby state, hit state, and moving state) of the contestants A, B according to the movement of the foreground objects (moving directions, moving speed, or moving distance of the contestants A, B, and a tennis ball), respectively. Similar, various states are stored in the corresponding event database, respectively. The processor unit further generates the strength charts of the contestants A, B according to the movement of the foreground objects, and determines the serving or hitting strength according to the movement categories of the contestants A, B, thereby simulating the competition result of the contestants each other.

For the conventional games, it requires many game development engineers to structure or render the players and scenes in the game, which consumes lots of time and costs. However, the method for interacting with a video and the game simulation system disclosed in the present invention can generate any game from any video. That is, after displaying a video, a game would be generated from the video content according to the method provided in the present invention. The viewer can play the newest game at once without spending lots of time or costs building 3D models or rendering the stadium. The brand-new game generation method is the object that current game manufacturers are far behind to catch up. The present invention not only saves lots of costs but also improves more enjoyment.

Although specific embodiments have been illustrated and described, it will be appreciated by those skilled in the art that various modifications may be made without departing from the scope of the present invention, which is intended to be limited solely by the appended claims.

What is claimed is:

1. A method for interacting with a video by a motion detector, comprising:
executing a video-content-decomposition procedure to decompose the video into a background scene and at least one foreground object;
classifying the foreground objects according to the state of the foreground objects to store them in at least one event database; and
selecting the suitable foreground objects from the event database according to a detected motion by the motion detector;
wherein the foreground objects selected are rendered on the background scene sequentially according to the detected motion.

2. The method of claim 1, wherein the video is composed of a plurality of sequent frame clips, and each foreground object is stored in the event database in sequence with timeline of the corresponding sequent frame clip.

3. The method of claim 2, further comprising a step of executing a moving path closing procedure, comprising the steps of:
detecting a beginning position where the foreground object currently locates at;
forecasting a destination position where the foreground object wants to move to; and
finding at least one sequence frame clip, which is close to the path from the beginning position to the destination position, from the event database, and displaying the found sequence frame clip.

4. The method of claim 3, wherein the step of executing the video-content-decomposition procedure comprises:
pre-determining a high threshold value, a low threshold value, and an alpha value;
comparing the background scene with the video and getting their difference; and
calculating weighted the portion, that the difference within the range between the high threshold value and the low threshold value, with the alpha value, so as to separate the foreground object by outlining the rim thereof.

5. The method of claim 4, further comprising:
executing a gathering procedure, which gathers the moving directions and speeds of the foreground object, to generate a corresponding strength chart;
wherein, when detecting the motion, the moving directions and speeds of the foreground object on the background scene may be controlled according to the strength chart.

6. The method of claim 4, further comprising:
executing a normalizing procedure to adjust the position and size of each foreground object on the background scene.

7. The method of claim 4, further comprising:
executing a path simplifying procedure to simplify the moving directions of the foreground objects.

8. The method of claim 1, further comprising:
executing a smoothing procedure to interpolate at least one smooth frame between the two cascading frames of the foreground object.

9. The method of claim 1, wherein each foreground object has a texture feature and a shape feature, and the next displayed foreground object is determined according to the similarity of the texture and the shape features.

10. The method of claim 1, wherein when changing current state of the motion, the adaptive foreground object may be selected from the corresponding event database to display.

11. The method of claim 10, wherein the states of the foreground objects comprises a serving state, a standby state, a hit state, and a moving state, which are stored in the corresponding event databases, respectively.

12. The method of claim 1, wherein the background scene comprises a stadium, and the foreground objects comprise a ball and at least one player.

13. The method of claim 1, wherein the motion detector is selected from a group consisting of user-operated controller, motion sensor, or image sensor and combinations thereof.

14. The method of claim 13, wherein the motion sensor comprises an Xbox 360 motion-sensor.

15. The method of claim 13, wherein the input operations of the user-operated controller comprises input instructions from a keyboard, input instructions from a mouse, input instructions from a joystick, dynamical input from Wiimote™, dynamical input from PlayStation® Move, or the combinations thereof.

16. The method of claim 1, further comprising:
selecting the adaptive foreground object to display according to the properties of the stored foreground object.

17. The method of claim 16, wherein the video is a tennis video.

18. The method of claim 17, wherein the properties of the foreground object in the tennis video comprises moving path, hitting motion, or hitting behavior.

19. The method of claim 18, further comprising:
forecasting victory or defeat of the foreground objects according to their properties.

20. The method of claim 1, further comprising:
building a 3D structure from the background scene; and
transforming into the 2D frame from the 3D structure in any viewing angle.

21. A game simulation system, comprising:
a database; and
a processor unit configured to decompose at least one game video of at least one contestant into a plurality of foreground objects and classify the movement categories of said contestant to store in the database according to the movement of the foreground objects, wherein the competition result of the contestants could be simulated according to the movement categories of said contestant and another contestant in the database.

22. The system of claim 21, wherein the processor unit decomposes at least one game video of said another contestant into a plurality of foreground object and classify the movement categories of said another contestant to store in the database.

23. The system of claim 21, wherein the game of there contestants comprises one-to-one competition, many-to-many competition, or one-to-many competition.

24. The system of claim 21, wherein the foreground objects comprise the contestants, and the movement of the foreground objects comprises moving directions, moving speed, or moving distance of the contestants.

25. The system of claim 24, wherein the movement of the foreground objects further comprises an attack strength of these contestants, wherein the processor unit gathers these moving directions, moving speed, and moving distance of the foreground objects to generate the corresponding strength charts of these contestants, respectively, thereby determining the attack strength of these contestants.

26. The system of claim 21, wherein said movement category comprises punching state, kicking state, defense state, and moving state, which are stored in the corresponding event database.

27. The system of claim 24, wherein the foreground objects comprise a ball, and the movement of the foreground objects comprises moving directions, moving speed, or moving distance of the ball.

28. The system of claim 27, wherein the movement of the foreground objects further comprises a hitting strength of these contestants, wherein the processor unit gathers these moving directions, moving speed, and moving distance of the foreground objects to generate the corresponding strength charts of these contestants, respectively, thereby determining the hitting strength of these contestants.

29. The system of claim 27, wherein said movement category comprises serving state, standby state, hit state, and moving state, which are stored in the corresponding event database.
